(19) United States
(12) Patent Application Publication
(10) Pub. No.: US 2007/0124385 A1
(43) Pub. Date: May 31, 2007

(54) Preference-based content distribution service

(76) Inventors: Michael S. Denny, Sharpsburg, GA (US); Joseph E. Page JR., Suwanee, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(21) Appl. No.: 11/283,458

(22) Filed: Nov. 18, 2005

(51) Int. Cl. G06F 15/16

(52) U.S. Cl. 709/206

(57) ABSTRACT

Embodiments of the present disclosure provide methods and devices for distributing content over a network. In this regard, one embodiment of such a method, among others, can be broadly summarized by the following steps: receiving an electronic message addressed to a single network account; categorizing content of the electronic message into at least one content category; and providing access to the content to users that have previously indicated a preference for information corresponding to the categorized content. Other methods and devices are also provided.

### TECHNICAL FIELD

The present disclosure is generally related to network communications and, more particularly, is related to delivery of network communications.

### BACKGROUND

Frequently, business users send general business information to a distribution list of e-mail recipients. For example, someone may discover an article of interest about which he or she assumes that his or her colleagues are also interested and include the article in an electronic message addressed to the person's colleagues via a distribution list from an electronic messaging address book.

While a business user may expect that recipients of the message are interested in the information being shared, some of the recipients may not be interested in the material or the information being shared, regardless of the well-meaning intentions of the sender. Since a person may receive numerous of these messages during a workday, this causes consumption of a lot of network bandwidth and data storage. Further, the productivity of business users is also wasted for users who are not interested in such content and have to take the time to remove such content from their inbox daily. This problem also persists outside the business context, e.g., in the home.

Thus, a heretofore unaddressed need exists in the industry to address the aforementioned deficiencies and inadequacies.

### SUMMARY

Embodiments of the present disclosure provide methods and devices for distributing content over a network. In this regard, one embodiment of such a method, among others, can be broadly summarized by the following steps: receiving an electronic message addressed to a single network account; categorizing content of the electronic message into at least one content category; and providing access to the content to users that have previously indicated a preference for information corresponding to the categorized content.

Embodiments also include a computer readable medium having a computer program for performing the above steps. Other methods, features, devices, and advantages of the present disclosure will be or become apparent to one with skill in the art upon examination of the following drawings and detailed description. It is intended that all such additional systems, methods, features, and advantages be included within this description and be within the scope of the present disclosure.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of one embodiment, among others, of a communications distribution network of the present disclosure.

FIG. 2 is a block diagram representation of an embodiment of a message servicing system utilized in the system of FIG. 1.

FIG. 3 is a flow chart describing one embodiment of the functionality of a content selection service provided by the system of FIG. 1.

FIG. 4 is a flow chart describing one embodiment of a process for originating and sending an electronic message of content in accordance with the system of FIG. 1.

FIG. 5 is a flow chart describing one embodiment of a process for subscribing to an embodiment of the content selection service provided by the system of FIG. 1.

FIG. 6 is a flow chart describing the functionality of one embodiment, among others, of a content selection service provided by the system of FIG. 1.

FIG. 7 is a diagram representing an embodiment of web interface for specifying one or more categories in accordance with content selection service provided by the system of FIG. 1.

FIGS. 8-9 are diagrams representing embodiments of notification e-mail messages from a content selection service provided by the system of FIG. 1.

FIG. 10 is a diagram representing an embodiment of a Web page providing accessing to categorized content of a content selection service provided by the system of FIG. 1.

FIG. 11 is a block diagram of a general purpose computer that implements select functionality of the content selection service provided by the system of FIG. 1, in one embodiment.

### DETAILED DESCRIPTION

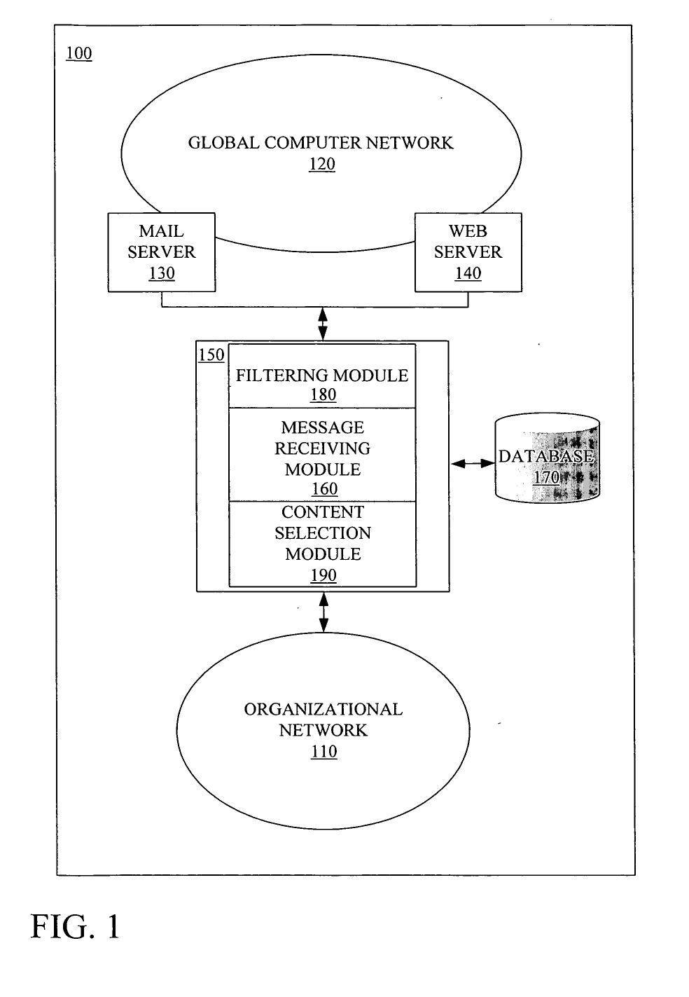

With reference to FIG. 1 of the drawings, a communications distribution network 100 for the transmission and delivery of electronic messages is shown. The network 100 includes a global computer network 120, such as the Internet, and any computer network and/or telecommunications network, including wireless, mobile, WAN, LAN or MAN networks. The electronic messages may take the form of, for example, e-mails, Web-page forms, SMS (Short Message Service) text messages, as commonly used by computers or personal digital assistants, or the like. It will be understood that the present disclosure is not limited for use with any particular such type or types of electronic messages.

The electronic messages are transmitted across the communications distribution network 100 using, for example, a mail server 130 and/or a Web server 140, as appropriate, and using transmission protocols such as, WAP (Wireless Application Protocol), HTTP (Hyper Text Transfer Protocol), SMTP (Simple Mail Transfer Protocol), POP (Post Office Protocol), or other suitable protocol. It will be understood that the disclosure is not limited to use with any particular transmission means or protocols.

The electronic messages are received by a message servicing system 150 (e.g., an e-mail server) which may reside, for example, on an organization's, such as, but not limited to, a corporation's, computer system (not shown) and network 110. The message servicing system 150 includes means for receiving electronic messages, which, in the example of FIG. 1, includes a message receiving module 160 and a database 170 for storing received messages.

In the example illustrated in FIG. 1, the message receiving module 160 is arranged to receive e-mails in two ways. One is directly from the global communication network 120 using SMTP, and a second is via the mail server 130 using POP3. The message receiving module 160 is further arranged to receive Web-page form messages through the Web server 140. Web-page form messages may be considered as structured electronic messages, which call a servlet in the Web server 140, which in turn converts, the Web-page form content into an electronic message, such as e-mail, which is subsequently sent to the message receiving module 160 using SMTP.

At the message receiving module 160, various administrative functions are performed, such as checking whether the addressee of an electronic message is an authorized user of the messaging servicing system 150. Then, the electronic message is placed in a storage space reserved for that user, referred to as an inbox, within a database 170.

After receiving electronic messages by the message receiving module 160, a filtering module 180 may attempt to remove electronic messages that are deemed potentially malicious, violate network policies, or are from unknown sources. Such messages are often referred to as “spam.” For example, the filtering module 180 may implement an exclusion list of known “spammers” so that mail from senders on the exclusion list are filtered out of incoming mail before being delivered to a user's inbox. Note, that electronic messages received from outside an organizational or corporate network 110 are scanned by the filter module 180, and that electronic messages sent between users of the organizational network 110 may not be subject to the same level of scrutiny as electronic messages originating from outside the organizational network 110.

For example, while an electronic message sent between users of the organizational network 110 may be analyzed by the messaging servicing system 150 employed on the organizational network 110 to make sure that the message complies with organizational policies, an electronic message from any user of the organizational network is capable of being sent to any other user, as long as the content of the message does not violate organizational policies. As discussed below, additional modules, such as a content selection module 190, are also part of the messaging servicing system 150.

Note that each module of the messaging servicing system 150 may reside on a single computer or may be distributed across a computer system, as is convenient. Further, the communications distribution network 100 of FIG. 1 is given by way of example only to provide a context for the present disclosure and is not limiting to the embodiments discussed herein.

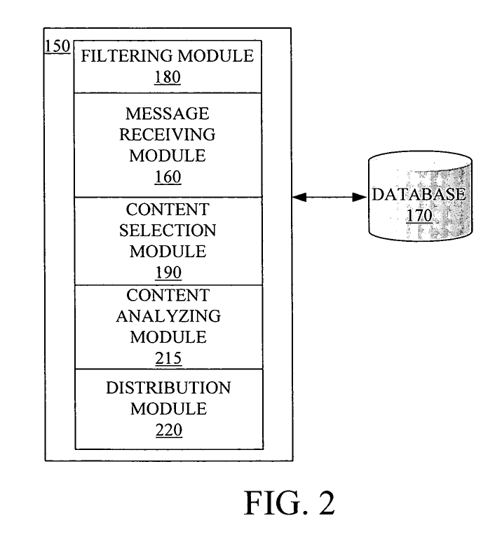

Referring now to FIG. 2, an embodiment of the message servicing system 150 is shown in more detail. Electronic messages received by the message receiving module 160 are stored in database 170 and in storage spaces or inboxes reserved for users of the messaging servicing system 150. According to an exemplary embodiment, an inbox is also designated and associated for a content selection service. Accordingly, electronic messages addressed to a network address of the content selection service are automatically placed in the inbox for the content selection service (“content selection inbox”).

A content selection module 190 retrieves each message from the content selection inbox maintained in the database 170. One function of the content selection module 190 is to categorize or index contents of each message received by the content selection inbox into one or more categories. To this end, the content selection module 190 is associated with, or includes, a content analyzing module 215, and is further associated with, or includes, a rule engine (not shown). In one embodiment, the content analyzing module 215 analyzes a received message for specific keywords, associations of keywords (e.g., analyzing if multiple keywords are contained in the same sentence), frequency of use of keywords, etc. in order to classify or index the message as pertaining to one or more categories of subject matter. Further, in some embodiments, the content analyzing module 215 may also analyze a received message to ensure that the content complies with organizational policies and discard the message if it violates organizational policies (e.g., objectionable subject matter, size of message is too large, etc.)

Further, in one embodiment, the content analyzing module 215 supports concept mapping via use of linguistic analysis techniques in mapping content. For example, a user could subscribe to “basketball” which would match “free throw”, “dunk,” “hoops,” etc. even though “basketball” might not be in those artifacts although they all relate to the same concept.

Once categorized or indexed, the content of each message is returned to the database 170 by the content selection module 190 together with the determined categorization information. Accordingly, if the content of an electronic message primarily contains a document as an attachment, then the document may be extracted from the message and stored in the database 170. Alternatively, if the content of the electronic message primarily contains text within the body of the message, then the text in the body of the message may be extracted and saved as a separate file within the database 170.

Based upon the categorization information, the content of the electronic message is made available to users of the message servicing system 150 who have indicated a preference for receiving content of that type. For example, the database 170 may maintain profiles of users that indicate categories of information or content that are desired by the respective users. Therefore, messages with content within certain categories may be automatically routed to interested users by a distribution module 220 of the message servicing system 150.

The distribution module 220 retrieves the categorized messages and distributes them to the inboxes of users, according to the respective categorization and preference information designated by respective users. The distribution module 220 includes one or more software routines that automatically generate an appropriate response to received content according to its categorization information. In one embodiment, the distribution module 220 sends notification messages to appropriate users with hypertext links to the received content that is being stored in the database 170.

In one embodiment, the content analyzing module 215 is capable of determining multiple categories for a given electronic message. When an electronic message is processed by the content analyzing module 215, the content analyzing module 215 applies a set of rules to the content of the electronic message in order to determine the subject matter of the message, where there may be more than one. In this way, the content analyzing module 215 is able to classify, or categorize, the electronic message according to its content. Some messages may include more than one subject area and may therefore fall into more than one different class or category. For example, an article with the title “Paying College Football Athletes” may be deemed to fall in more than one category, such as “Legal,” “Sports,” “Financial,” “Academics,” etc. The content analyzing module 215 is therefore arranged to generate one or more categories for each message that it processes, depending on the content of each message.

In one embodiment, the content analyzing module 215 examines the text of each message, including attachments, in search of one or more alphanumeric text strings (e.g., a word or sequence of words), which may be used to identify the subject matter of the content under examination. The content analyzing module 215 may operate in association with a rule engine (not shown) to apply a set of rules to the message in order to determine how to categorize the current message.

For each user of the content selection service (via the messaging servicing system 150), the user specifies categories of content that are of interest to the user. This information may be maintained in a profile of the user stored on the database 170. Accordingly, after a message has been indexed or categorized within a certain category by the content selection module 190, the distribution module 220 prepares notification messages that are sent to users who have profiles that indicate a preference for receiving content of that type.

In one embodiment, the content selection service is targeted at organizational networks 110 and message servicing systems 150, such as corporate networks and servers. As such, it addresses the type of messages that are often internally generated within corporate networks, such as a person sending a tutorial article on web services to everyone in his or her organizational unit, whether the eventual recipients desire the tutorial or not. In contrast, in accordance with embodiments of the present disclosure, a person sends one message to the content selection service which then manages delivery of the message to recipients that have already indicated a preference for receiving messages of that type or category.

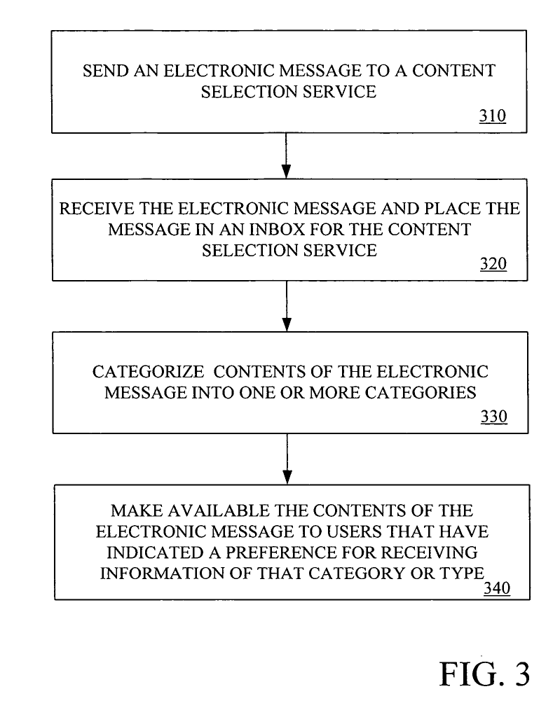

Referring now to FIG. 3, a flow chart describing one embodiment of the functionality of the content selection service is described. First, as shown in block 310, a sender includes a document within an electronic message and sends the electronic message to a network address of a content selection service. Note that the sender does not necessarily have to be a registered user of a message servicing system 150 of an organizational network 110, where the content selection service is employed. Also, in different embodiments, the document may include media of different types, including text, video, music, images, etc., and the content analyzing module 215 may thus be configured to analyze the content of different types of media. In the present example, it is assumed that the document is, but not necessarily limited to, a text document.

The electronic message is received (320) at a message server (e.g., message servicing system 150) that handles incoming electronic messages for the network address of the content selection service and places the received message in an inbox associated with the network address (e.g., an e-mail address) of the content selection service. The inbox of the network address is associated with a content selection module 190 that is part of or works in conjunction with the message server (e.g., messaging servicing system 150) and processes messages delivered to the inbox for the content selection service. Accordingly, the content selection module 190 analyzes (or requests another module, working in conjunction, to analyze) the content of the received electronic message and categorizes or indexes the content of the received electronic message. After categorizing (330) the contents of the message into one or more categories, the contents of the message are made available (340) to users of the content selection service that have indicated a preference for receiving information of that category or type. For example, profiles of the users may indicate preferences for certain categories of information, and the profiles may be maintained on a database 170 that is accessible by a message server utilized by the content selection service.

In one embodiment, users subscribe to one or more categories of content. Accordingly, any content received by the content selection service that is classified as a category that is subscribed by a user is then made available to the user. In particular, the content selection module 190 (or some other related module) maps the categories associated with a received electronic message with categories that have been subscribed by users (as expressed in user profiles). Note that in some embodiments, a user must be a recognized user of the message server in order to be allowed to subscribe to content categories.

In some embodiments, the content, such as an attachment, is sent to the inbox of the user via an e-mail message. In other embodiments, a notification message is sent to the inbox of the user with instructions for accessing the document, such as a hypertext link to the document at a network location that may be accessed via a Web browser or other computer application.

In this way, individual users may self-identify their preferences for certain types of information and then receive only electronic messages of that type. This centralized approach to message distribution efficiently reduces the processing, overhead, and time requirements associated with information handling and is an alternative to information sharing via an e-mail distribution list.

Therefore, instead of a sender broadcasting an electronic message across a network, the sender may send the message to one recipient—an account of the content selection service. The content selection service then consumes the content of the message and allows individuals that have subscribed to the service to receive the message, if there is a mapping between a category classification of the message and categories preferred and previously identified by the individuals. The content selection service, in this way, represents the specified interests of its users and delivers desired content to the users. In so doing, the content selection service also provides a mechanism for making content available to numerous users, without a sender having to target specific individuals. In other words, the sender is figuratively sending an electronic message having content of interest to a community of interest managed by the content selection service.

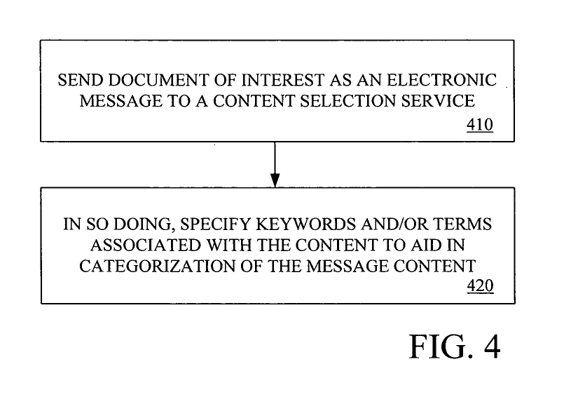

Referring now to FIG. 4, a flow chart describing one embodiment of a process for originating and sending an electronic message of content is described. First, a sender decides to share interesting information, such as an electronic document, which may be, but is not limited to, a technical article, with other persons. Instead of e-mailing the article to a distribution list, the sender directly sends (410) the document as an electronic message to a network address (e.g., an e-mail address) assigned to a content selection service. Further, in this embodiment, the sender may also specify (420), in the body of the message, keywords and/or terms associated with the content to aid in classification/categorization of the message content.

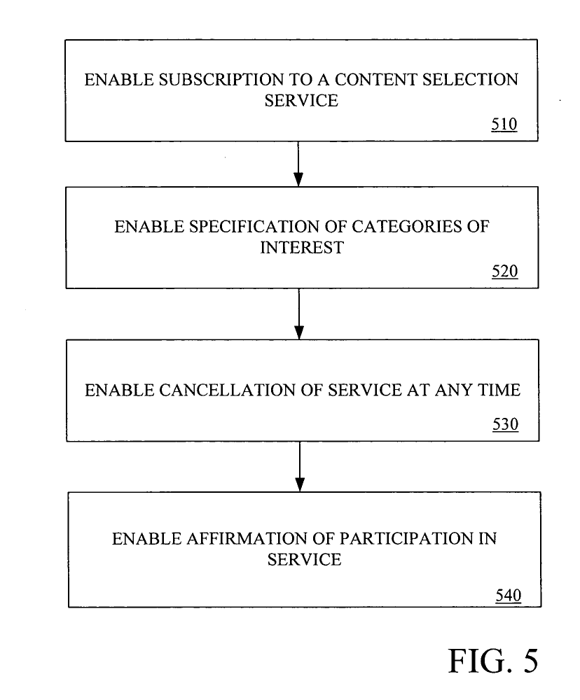

Next, in FIG. 5, a flow chart describing one embodiment of a process for subscribing to an embodiment of the content selection service is presented. If a user wants to receive information messages or electronic messages that have been sent or “posted” to a content selection service, the user subscribes (510) to the service and specifies (520) categories of interest. To do so, in some embodiments, a user may send an e-mail message to a special e-mail account of the content selection service, such as subscribe@contentselection[DOT]com. Further, the user may designate in a header of the message a designated keyword or parameter, such as “SUBSCRIBE,” where the e-mail address of the sender/user is automatically registered with the service. Accordingly, within the body of the e-mail message, the sender/user may include keywords and/or terms associated with the type of content the sender is interested in receiving from the service that will then be automatically sent to the e-mail address of the sender/user. Alternatively or in conjunction, a user may also access a web site affiliated with the content selection service and register online while also specifying the keywords and/or terms associated with the content of interest or by expressly selecting categories of content (an example of which is discussed hereafter).

Additional administrative functions are enabled to be performed by a user as part of the content selection service. For example, the user may cancel (530) the service at any time. For example, in one embodiment, the user may send an e-mail message to a special e-mail account of the content selection service, such as one that may be used to subscribe to the service, in one embodiment. Accordingly, to indicate that the user desires to cancel use of the service, the user may designate in a header of the message a particular keyword or parameter, such as “UNSUBSCRIBE,” that is automatically recognized by the content selection service as a request for cancellation. Likewise, in some embodiments, a user may also access a web site affiliated with the content selection service and make a request online to cancel his or her participation in the content selection service. Further, as part of the content selection service, a user may be prompted to affirm (540) participation in the service. For example, in one embodiment, the content selection service may periodically send an e-mail message to a user of the service asking the user to reply to the message in order to show that the user is still interested in participating in the service. In other embodiments, such messages may be sent to users after a designated period of inactivity by the user, as detected by the content selection service (e.g., by detecting that a user has not read any notification messages in a set period of time). In this way, the content selection service can manage delivery of content to users who evince an interest in receiving the content.

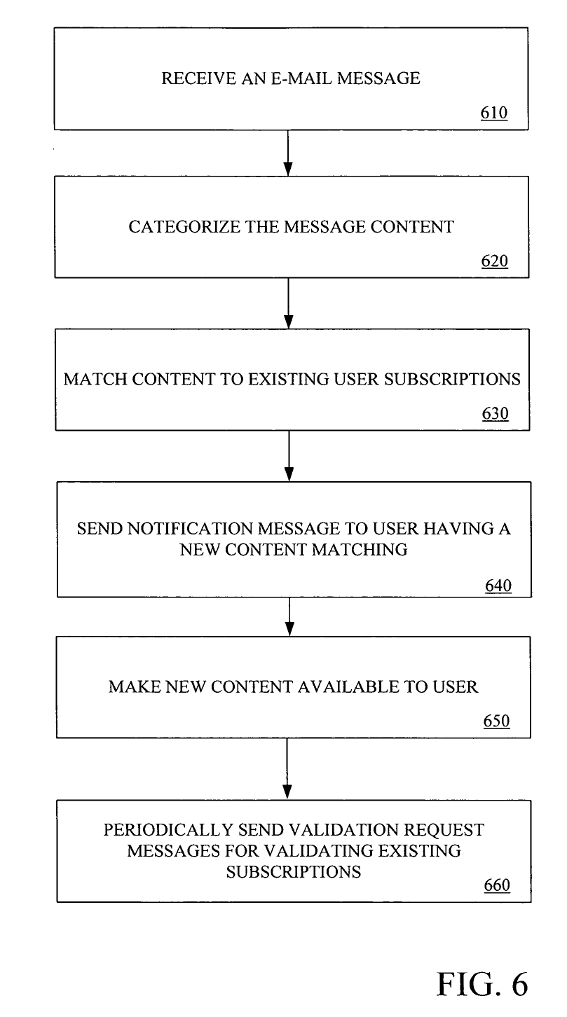

In one embodiment, actions performed by a process of an embodiment of the content selection service are shown in FIG. 6. Here, the content selection service is, but not limited to, a centralized e-mail service that has an associated e-mail user account and e-mail inbox. When an e-mail message is received (610), the e-mail subscription service invokes a content selection module 190 which automatically indexes/categorizes (620) the incoming message content and stores the message in an indexed content store (such as within a storage area of database 170). After a new e-mail message has been received and indexed, the content selection module 190 then matches (630) the new content to existing user subscriptions. To do so, the content selection module retrieves all current subscription information from a subscription or profiles database (e.g., database 170) which stores all selection criteria for subscribed users, as maintained in user profiles. In some embodiments, this content selection process executes immediately on receipt/indexing of new messages. Alternatively, the process may be scheduled to run on periodic basis (or pre-set schedule).

When a subscription matches the new e-mail message, an e-mail notification message is sent (640) by an e-mail distribution module (e.g., distribution module 220) to notify the subscriber of a new content matching with the user's subscription has been received. The new content is then made available (650) to the user/subscriber. For example, in some embodiments, the original information sharing message could either be attached to the e-mail notice, or be made available via hyperlink to an e-mail store. As an additional function, the e-mail distribution module may also periodically send (660) validation request messages to users to validate existing subscriptions to the content selection service.

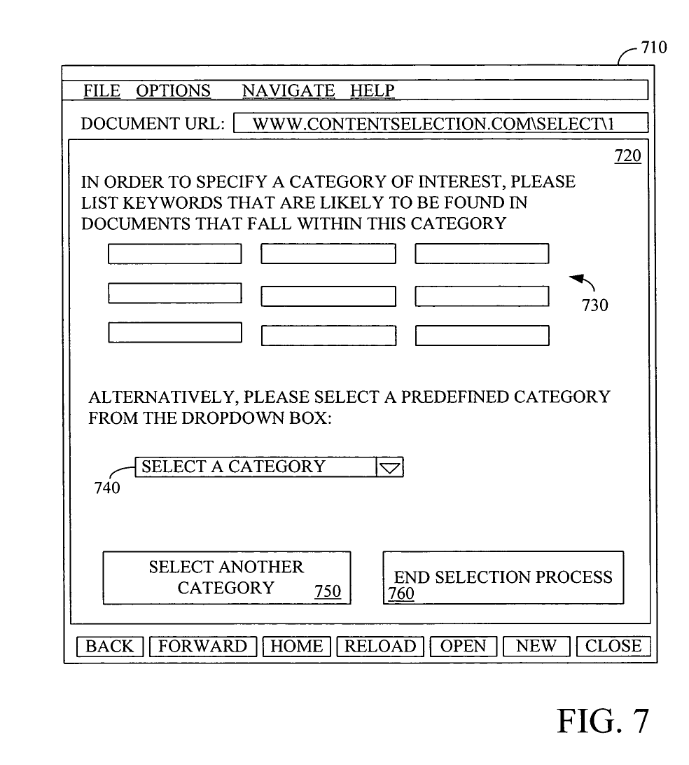

As explained previously, more than one approach may be used to specify categories of content that are of interest to a user of the content selection service. Accordingly, FIG. 7 shows one embodiment of a web interface for specifying one or more categories. The figure displays a representation of a Web browser 710 displaying a Web page 720 affiliated with the content selection service. Via the interface controls on the Web page 720, a user may specify a category of content. For example, a user has the option of specifying keywords associated with the category in the input boxes 730 shown in the top portion of the Web page. As a result, the content selection service may detect any new messages that contains one or more of the terms inputted by the user and make those messages available to the user. Alternatively, in some embodiments, the content selection service may map the inputted keywords to predefined categories that are then associated with the user.

Also, the user has the option of selecting a predefined category from a dropdown box 740 shown in the bottom portion of the Web page 710. After the user has specified a category, the user may then proceed to specify additional categories by selecting the SELECT ANOTHER CATEGORY button 750. Alternatively, if the user is finished selecting categories, then the user may select the END SELECTION PROCESS button 760. Note that the approach described in FIG. 7 is one of many different approaches that may be used to select one or more categories and the disclosure is not limited to the approach shown in FIG. 7.

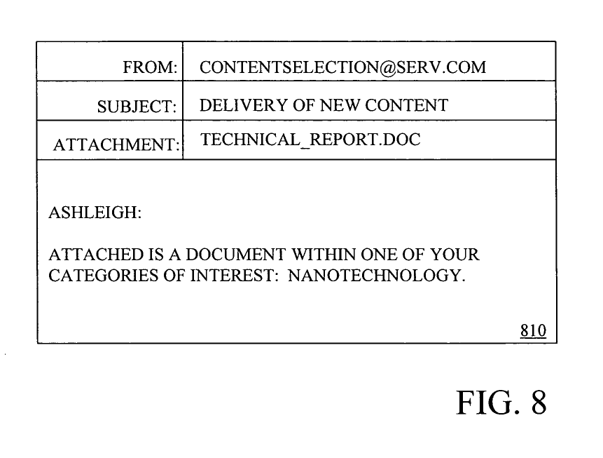

Correspondingly, a variety of approaches may also be used to retrieve a document identified by the content selection service for a particular user. For example, FIG. 8 depicts a representation of a notification e-mail message 810 that is sent to a user that has subscribed to the content selection service. As shown, the e-mail message 810 is from an e-mail account (“contentselection@serv[DOT]com”) of a customer selection service and includes an attachment named TECHNICAL_REPORT.DOC. Within the body of the e-mail message 810, the message contains a message explaining that the attached document is a document that matches one of the user's subscribed categories: Nanotechnology. Accordingly, in this implementation, the matching document is delivered directly to a user's e-mail inbox. In some embodiments, the notification message may also contain a preview of the contents of the document (e.g., first two lines of content, a two sentence synopsis, content summarization, etc.).

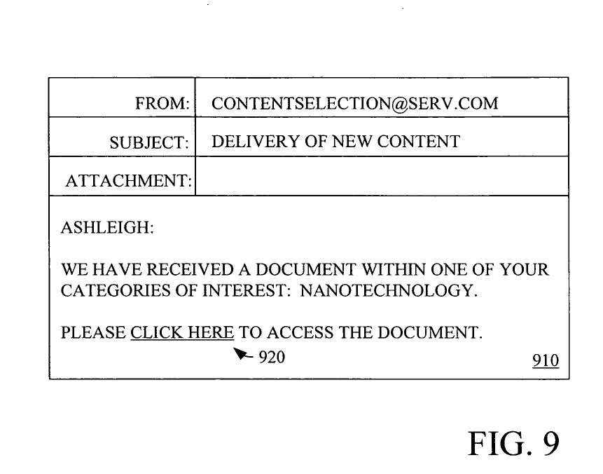

In another embodiment, as shown in FIG. 9, a user may receive a notification e-mail message 910 that is similar to the message of FIG. 8. However, in this message, there is no attachment. Rather, the message contains a hypertext link 920 to a network location hosting the matched document, such as a Web storage area maintained for the user by the content selection service.

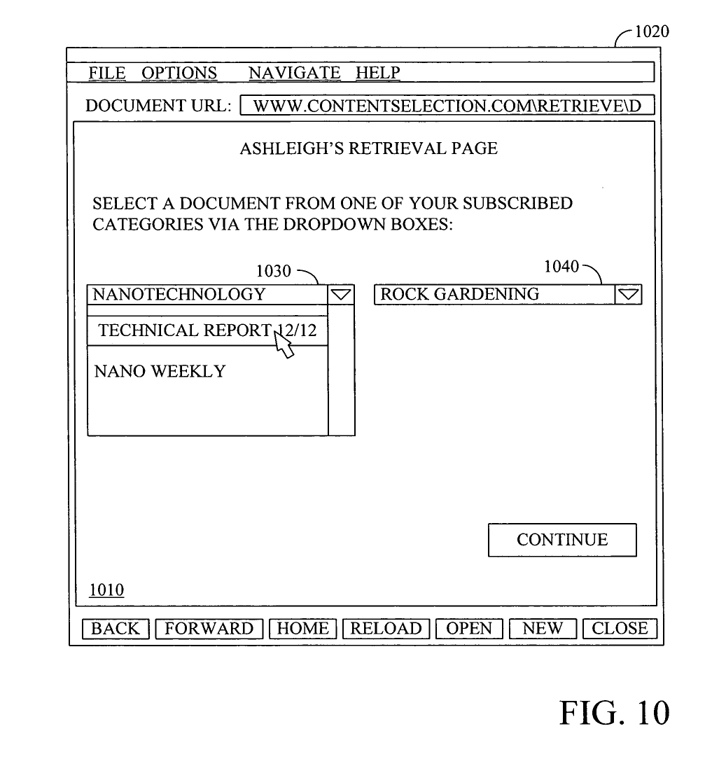

Accordingly, by activating the hypertext link 920 in the e-mail message 910 (e.g., by clicking on the link 920 with a mouse control), a Web browser may be directed, via a computer, to retrieve a Web page at a network location associated with the hypertext link 920. For example, FIG. 10 shows a representation of a Web page 1010 retrieved by a Web browser and displayed within a browser interface 1020 after activating the hypertext link 920, for one embodiment. As shown, the Web page 1010 displays two dropdown boxes 1030, 1040 that are associated with two categories (“Nanotechnology” and “Rock Gardening”) to which a user (“Ashleigh”) has subscribed. By using the dropdown boxes 1030, 1040, the user may select a document that has been indexed under a respective category, where the user has previously indicated a preference for receiving information of that type.

In the example shown, two documents are capable of being accessed by the user for the NANOTECHNOLOGY category in drop down box 1030. Namely, the documents are identified as “Technical Journal 12/12” and “Nano Weekly.” By clicking on the title, a Web browser 1020 may then download the document for the user to view.

Note that many variations and modifications may be made to the above-described embodiments. For example, in one alternative embodiment, all incoming mail to a user's inbox, in general, may be analyzed by a content selection module 190 such that the content is categorized and placed in an appropriate folder, where different folders are associated with different categories. In this way, incoming e-mail is automatically organized into organizational units rather than being stored in one inbox. Further, in some embodiments, a user may specify rules indicating where to sort incoming messages categorized or indexed by the content selection module 190. Accordingly, an e-mail client of the user may retrieve a message from the user's inbox with a categorization of the message such that the e-mail client then processes the rules designated by the user for filing or sorting such content, such as a designated folder.

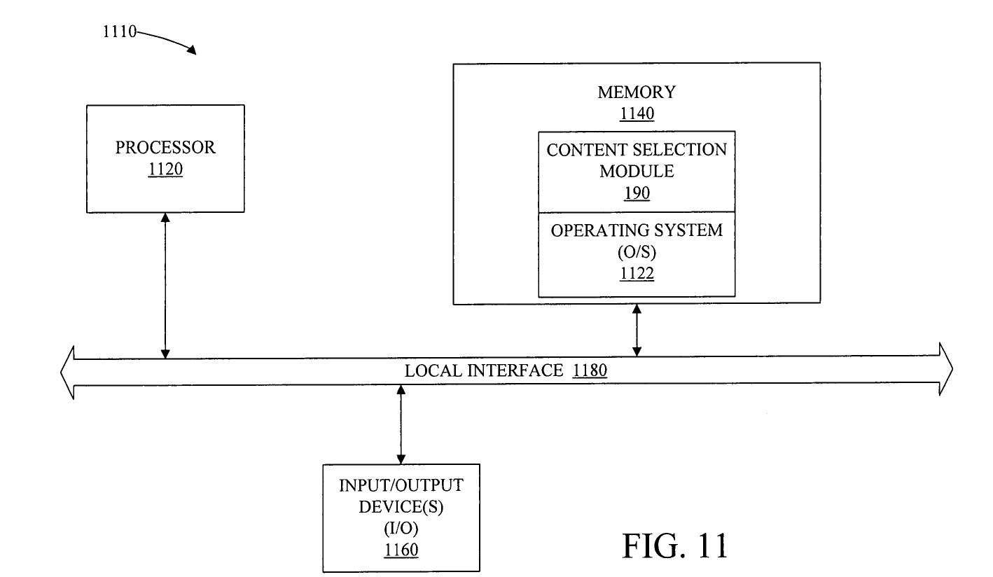

Aspects of embodiments of the present disclosure, such as the content selection module 190, among others, can be implemented in hardware, software, firmware, or a combination thereof. In one embodiment, for example, the content selection module 190 is implemented in software or firmware that is implemented stored in a memory and that is executed by a suitable instruction execution system, such as a special or general purpose digital computer, such as a personal computer (PC; IBM-compatible, Apple-compatible, or otherwise), workstation, minicomputer, or mainframe computer. An example of a general purpose computer that can implement the content selection module 190 of the present disclosure is shown in FIG. 11. In FIG. 11, the content selection module is denoted by reference numeral 190.

Generally, in terms of hardware architecture, as shown in FIG. 11, the computer 1110 includes a processor 1120, memory 1140, and one or more input and/or output (I/O) devices 1160 (or peripherals) that are communicatively coupled via a local interface 1180. The local interface 1180 can be, for example but not limited to, one or more buses or other wired or wireless connections, as is known in the art.

The processor 1120 is a hardware device for executing software, particularly that stored in memory 1140. The memory 1140 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 1140 may incorporate electronic, magnetic, optical, and/or other types of storage media. Note that the memory 1140 can have a distributed architecture, where various components are situated remote from one another, but can be accessed by the processor 1120.

The software in memory 1140 may include one or more separate programs, each of which comprises an ordered listing of executable instructions for implementing logical functions. In the example of FIG. 11, the software in the memory 1140 includes the content selection module 190 in accordance with the present disclosure and a suitable operating system (O/S) 1122. The operating system 1122 controls the execution of other computer programs, such as the content selection module 190, and provides scheduling, input-output control, file and data management, memory management, and communication control and related services.

The I/O devices 1160 may include input devices, for example but not limited to, a keyboard, mouse, scanner, microphone, etc. Furthermore, the I/O devices 1160 may also include output devices, for example but not limited to, a printer, display, etc. Finally, the I/O devices 1160 may further include devices that communicate both inputs and outputs, for instance but not limited to, a modulator/demodulator (modem; for accessing another device, system, or network), a radio frequency (RF) or other transceiver, a telephonic interface, a bridge, a router, etc.

If the computer 1110 is a PC, workstation, server, or the like, the software in the memory 1140 may further include a basic input output system (BIOS) (omitted for simplicity). The BIOS is a set of software routines that initialize and test hardware at startup, start the O/S 1122, and support the transfer of data among the hardware devices. The BIOS is stored in ROM so that the BIOS can be executed when the computer 1110 is activated.

When the computer 1110 is in operation, the processor 1120 is configured to execute software stored within the memory 1140, to communicate data to and from the memory 1140, and to generally control operations of the computer 1110 pursuant to the software. The content selection module 190 and the O/S 1122, in whole or in part, are read by the processor 1120, perhaps buffered within the processor 1120, and then executed.

When the content selection module 190 is implemented in software, as is shown in FIG. 11, it should be noted that the content selection module 190 can be stored on any computer readable medium for use by or in connection with any computer related system or method. In the context of this document, a computer readable medium is an electronic, magnetic, optical, or other physical device or means that can contain or store a computer program for use by or in connection with a computer related system or method.

If implemented in hardware, as in an alternative embodiment, the content selection module 190 can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Any process descriptions or blocks in flow charts should be understood as representing modules, segments, or portions of code which include one or more executable instructions for implementing specific logical functions or steps in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

It should be emphasized that the above-described embodiments are merely possible examples of implementations, merely set forth for a clear understanding of the principles of the disclosure. Many variations and modifications may be made to the above-described embodiments without departing substantially from the spirit and principles of the disclosure. All such modifications and variations are intended to be included herein within the scope of this disclosure.

1. A method for distributing content over a network, comprising:
receiving an electronic message addressed to a single network account;
categorizing content of the electronic message into at least one content category; and
providing access to the content to users that have previously indicated a preference for information corresponding to the categorized content.

2. The method of claim 1, wherein access is provided to users by sending the content of the electronic message in an electronic message to network addresses of the users.

3. The method of claim 1, wherein access is provided to users by sending a hypertext link to the content of the electronic message, the hypertext link being sent via an electronic message addressed to network addresses of the users.

4. The method of claim 1, further comprising:
maintaining user profiles, each user profile specifying at least one preference indicating a category of information that the respective user is interested in receiving.

5. The method of claim 1, wherein the content of the electronic message is categorized in a plurality of content categories, such that users having user profiles indicating a preference for any of the content categories is provided access to the content of the electronic message.

6. The method of claim 1, further comprising:
receiving an expression of interest in a type of information that a first user is interested in receiving, wherein the expression of interest comprises a list of keywords provided by the first user.

7. The method of claim 6, further comprising:
associating the list of keywords with a content category.

8. The method of claim 6, further comprising:
searching the content of the electronic message to determine whether any of the keywords are included in the content of the electronic message; and
based upon results of the searching step, determining whether the content of the electronic document is of interest to the first user.

9. The method of claim 1, wherein:
a plurality of users subscribe to a plurality of content categories;
the content of the electronic document is categorized as belonging to a plurality of content categories; and
the electronic document is distributed to a plurality of users belonging to a plurality of subscriptions based upon the categorizing step.

10. The method of claim 1, wherein a sender of the electronic message is not required to be a recognized user of a messaging system that manages the single network account, whereas recipients of content of the electronic message are required to be recognized users of the messaging system.

11. A computer readable medium having a computer program for distributing content over a network, the program having instructions for performing the steps of:
receiving an electronic message addressed to a single network account;
categorizing content of the electronic message into at least one content category; and
providing access to the content to users that have previously indicated a preference for information corresponding to the categorized content.

12. The computer readable medium of claim 11, wherein access is provided to users by sending the content of the electronic message in an electronic message to network addresses of the users.

13. The computer readable medium of claim 11, wherein access is provided to users by sending a hypertext link to the content of the electronic message, the hypertext link being sent via an electronic message addressed to network addresses of the users.

14. The computer readable medium of claim 11, the program having instructions for performing the step of:
maintaining user profiles, each user profile specifying at least one preference indicating a category of information that the respective user is interested in receiving.

15. The computer readable medium of claim 11, wherein the content of the electronic message is categorized in a plurality of content categories, such that users having user profiles indicating a preference for any of the content categories is provided access to the content of the electronic message.

16. The computer readable medium of claim 11, the program having instructions for performing the step of:
receiving an expression of interest in a type of information that a first user is interested in receiving, wherein the expression of interest comprises a list of keywords provided by the first user.

17. The computer readable medium of claim 16, the program having instructions for performing the step of:
associating the list of keywords with a content category.

18. The computer readable medium of claim 16, the program having instructions for performing the steps of:
searching the content of the electronic message to determine whether any of the keywords are included in the content of the electronic message; and
based upon results of the searching step, determining whether the content of the electronic document is of interest to the first user.

19. The computer readable medium of claim 11, wherein:
a plurality of users subscribe to a plurality of content categories;
the content of the electronic document is categorized as belonging to a plurality of content categories; and
the electronic document is distributed to a plurality of users belonging to a plurality of subscriptions based upon the categorizing step.

20. The computer readable medium of claim 11, wherein a sender of the electronic message is not required to be a recognized user of a messaging system that manages the single network account, whereas recipients of content of the electronic message are required to be recognized users of the messaging system.
